(19) United States
(12) Patent Application Publication
(10) Pub. No.: US 2015/0097989 A1
(43) Pub. Date: Apr. 9, 2015

(54) ZOOM LENS SYSTEM, INTERCHANGEABLE LENS APPARATUS AND CAMERA SYSTEM

(71) Applicant: Panasonic Corporation, Osaka (JP)

(72) Inventors: Hideki KAI, Osaka (JP); Takahiro KITADA, Osaka (JP); Takuya IMAOKA, Kanagawa (JP)

(73) Assignee: Panasonic Corporation, Osaka (JP)

(21) Appl. No.: 14/227,257

(22) Filed: Mar. 27, 2014

(30) Foreign Application Priority Data
Oct. 7, 2013 (JP) 2013-210322

(51) Int. Cl. G02B 13/04; H04N 5/232

(52) U.S. Cl. CPC G02B 13/04; H04N 5/23296
USPC 348/240.3; 359/680

(57) ABSTRACT

A zoom lens system comprising: a negative first lens unit; a positive second lens unit; a negative third lens unit; and a positive fourth lens unit, wherein in zooming, the first lens unit moves with locus of a convex to the image side and the second lens unit moves to the object side, and the conditions: 0<(D_{aW}−D_{aT})/TL_{W}<0.26 and 0<TG_{2G}/TGₐ₁₁<0.4 (D_{aW}: optical axial interval between the first and second lens units at the wide-angle limit, D_{aT}: optical axial interval between the first and second lens units at the telephoto limit, TL_{W}: overall length of the lens system at the wide-angle limit, TG_{2G}: optical axial thickness of the second lens unit, TGₐₗₗ: sum of optical axial thicknesses of the respective lens units) are satisfied.

### CROSS-REFERENCE TO RELATED APPLICATION

This application is based on application No. 2013-210322 filed in Japan on Oct. 7, 2013, the contents of which are hereby incorporated by reference.

### BACKGROUND

1. Field

The present disclosure relates to zoom lens systems, interchangeable lens apparatuses, and camera systems.

2. Description of the Related Art

In recent years, interchangeable-lens type digital camera systems (also referred to simply as “camera systems”, hereinafter) have been spreading rapidly. Such interchangeable-lens type digital camera systems realize: taking of high-sensitive and high-quality images; high-speed focusing and high-speed image processing after image taking; and easy replacement of an interchangeable lens apparatus in accordance with a desired scene. Meanwhile, an interchangeable lens apparatus having a zoom lens system that forms an optical image with variable magnification is popular because it allows free change of focal length.

Zoom lens systems having excellent optical performance from a wide-angle limit to a telephoto limit have been desired as zoom lens systems to be used in interchangeable lens apparatuses. For example, various kinds of zoom lens systems, having a multiple-unit construction in which a negative lens unit is located closest to an object side, have been proposed.

Japanese Patent No. 5083219 discloses a variable magnification optical system having a four-unit construction of negative, positive, negative, and positive, in which the interval between a first lens unit and a second lens unit is decreased in zooming.

Japanese Laid-Open Patent Publication No. 2012-133228 discloses a zoom lens system having a four-unit construction of negative, positive, negative, and positive, in which a first lens unit including at least one lens element having positive optical power is moved in zooming.

### SUMMARY

The present disclosure provides a zoom lens system having excellent optical performance over the entire zoom range while being compact in size. Further, the present disclosure provides an interchangeable lens apparatus and a camera system each employing the zoom lens system.

The novel concepts disclosed herein were achieved in order to solve the foregoing problems in the related art, and herein is disclosed:

a zoom lens system, in order from an object side to an image side, comprising:

a first lens unit having negative optical power;

a second lens unit having positive optical power;

a third lens unit having negative optical power; and

a fourth lens unit having positive optical power, wherein

the first lens unit moves with locus of a convex to the image side in zooming from a wide-angle limit to a telephoto limit at a time of image taking

the second lens unit moves to the object side in the zooming, and

the following conditions (1) and (2) are satisfied:

0<(D_{aW}−D_{aT})/TL_{W}<0.26 (1)

0<TG_{2G}/TGₐ₁₁<0.4 (2)

where

D_{aW} is an optical axial interval between the first lens unit and the second lens unit at the wide-angle limit,

D_{aT} is an optical axial interval between the first lens unit and the second lens unit at the telephoto limit,

TL_{W} is an overall length of the lens system at the wide-angle limit being an optical axial distance from an object side surface of a lens element closest to the object side in the first lens unit to an image surface,

TG_{2G} is an optical axial thickness of the second lens unit, and

TGₐₗₗ is a sum of optical axial thicknesses of the respective lens units.

The novel concepts disclosed herein were achieved in order to solve the foregoing problems in the related art, and herein is disclosed:

an interchangeable lens apparatus comprising:

a zoom lens system; and

a lens mount section which is connectable to a camera body including an image sensor for receiving an optical image formed by the zoom lens system and converting the optical image into an electric image signal,

the zoom lens system, in order from an object side to an image side, comprising:

a first lens unit having negative optical power;

a second lens unit having positive optical power;

a third lens unit having negative optical power; and

a fourth lens unit having positive optical power, wherein

the first lens unit moves with locus of a convex to the image side in zooming from a wide-angle limit to a telephoto limit at a time of image taking

the second lens unit moves to the object side in the zooming, and

the following conditions (1) and (2) are satisfied:

0<(D_{aW}−D_{aT})/TL_{W}<0.26 (1)

0<TG_{2G}/TGₐ₁₁<0.4 (2)

where

D_{aW} is an optical axial interval between the first lens unit and the second lens unit at the wide-angle limit,

D_{aT} is an optical axial interval between the first lens unit and the second lens unit at the telephoto limit,

TL_{W} is an overall length of the lens system at the wide-angle limit being an optical axial distance from an object side surface of a lens element closest to the object side in the first lens unit to an image surface,

TG_{2G} is an optical axial thickness of the second lens unit, and

TGₐₗₗ is a sum of optical axial thicknesses of the respective lens units.

The novel concepts disclosed herein were achieved in order to solve the foregoing problems in the related art, and herein is disclosed:

a camera system comprising:

an interchangeable lens apparatus including a zoom lens system; and

a camera body which is detachably connected to the interchangeable lens apparatus via a camera mount section, and includes an image sensor for receiving an optical image formed by the zoom lens system and converting the optical image into an electric image signal,

the zoom lens system, in order from an object side to an image side, comprising:

a first lens unit having negative optical power;

a second lens unit having positive optical power;

a third lens unit having negative optical power; and

a fourth lens unit having positive optical power, wherein

the first lens unit moves with locus of a convex to the image side in zooming from a wide-angle limit to a telephoto limit at a time of image taking

the second lens unit moves to the object side in the zooming, and

the following conditions (1) and (2) are satisfied:

0<(D_{aW}−D_{aT})/TL_{W}<0.26 (1)

0<TG_{2G}/TGₐ₁₁<0.4 (2)

where

D_{aW} is an optical axial interval between the first lens unit and the second lens unit at the wide-angle limit,

D_{aT} is an optical axial interval between the first lens unit and the second lens unit at the telephoto limit,

TL_{W} is an overall length of the lens system at the wide-angle limit being an optical axial distance from an object side surface of a lens element closest to the object side in the first lens unit to an image surface,

TG_{2G} is an optical axial thickness of the second lens unit, and

TGₐₗₗ is a sum of optical axial thicknesses of the respective lens units.

The zoom lens system according to the present disclosure has excellent optical performance over the entire zoom range while being compact in size.

### BRIEF DESCRIPTION OF THE DRAWINGS

This and other objects and features of the present disclosure will become clear from the following description, taken in conjunction with the exemplary embodiments with reference to the accompanied drawings in which:

FIG. 1 is a lens arrangement diagram showing an infinity in-focus condition of a zoom lens system according to Embodiment 1 (Numerical Example 1);

FIG. 2 is a longitudinal aberration diagram of an infinity in-focus condition of the zoom lens system according to Numerical Example 1;

FIG. 3 is a lens arrangement diagram showing an infinity in-focus condition of a zoom lens system according to Embodiment 2 (Numerical Example 2);

FIG. 4 is a longitudinal aberration diagram of an infinity in-focus condition of the zoom lens system according to Numerical Example 2;

FIG. 5 is a lens arrangement diagram showing an infinity in-focus condition of a zoom lens system according to Embodiment 3 (Numerical Example 3);

FIG. 6 is a longitudinal aberration diagram of an infinity in-focus condition of the zoom lens system according to Numerical Example 3; and

FIG. 7 is a schematic construction diagram of an interchangeable-lens type digital camera system according to Embodiment 4.

### DETAILED DESCRIPTION

Hereinafter, embodiments will be described with reference to the drawings as appropriate. However, descriptions more detailed than necessary may be omitted. For example, detailed description of already well known matters or description of substantially identical configurations may be omitted. This is intended to avoid redundancy in the description below, and to facilitate understanding of those skilled in the art.

It should be noted that the applicants provide the attached drawings and the following description so that those skilled in the art can fully understand this disclosure. Therefore, the drawings and description are not intended to limit the subject defined by the claims.

### Embodiments 1 to 3

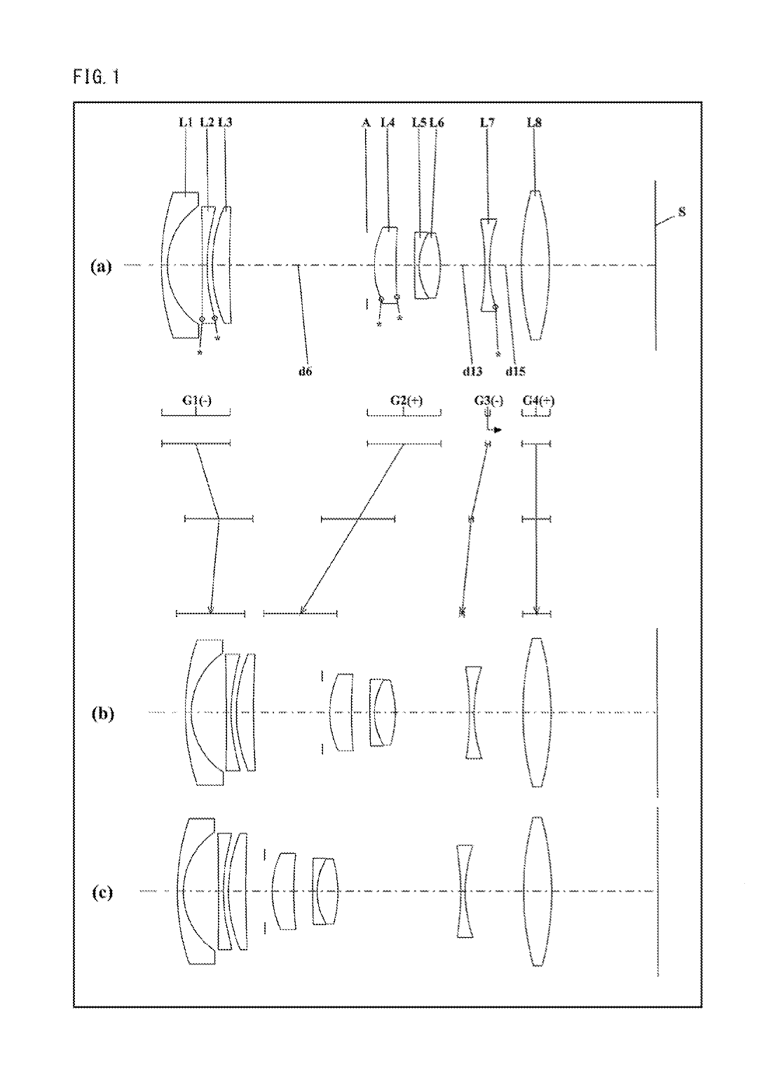

FIGS. 1, 3, and 5 are lens arrangement diagrams of zoom lens systems according to Embodiments 1 to 3, respectively. Each zoom lens system is in an infinity in-focus condition.

In each Fig., part (a) shows a lens configuration at a wide-angle limit (in the minimum focal length condition: focal length f_{w}), part (b) shows a lens configuration at a middle position (in an intermediate focal length condition: focal length f_{M}=\sqrt{(f_{W}*f_{T})}), and part (c) shows a lens configuration at a telephoto limit (in the maximum focal length condition: focal length f_{T}). Further, in each Fig., each bent arrow located between part (a) and part (b) indicates a line obtained by connecting the positions of each lens unit respectively at a wide-angle limit, a middle position and a telephoto limit, in order from the top. In the part between the wide-angle limit and the middle position and the part between the middle position and the telephoto limit, the positions are connected simply with a straight line, and hence this line does not indicate actual motion of each lens unit.

Further, in each Fig., an arrow imparted to a lens unit indicates focusing from an infinity in-focus condition to a close-object in-focus condition. That is, the arrow indicates a direction along which a third lens unit G3 described later moves in focusing from an infinity in-focus condition to a close-object in-focus condition. In FIGS. 1, 3, and 5, since the symbols of the respective lens units are imparted to part (a), the arrow indicating focusing is placed beneath each symbol of each lens unit for the convenience sake. However, the direction along which each lens unit moves in focusing in each zooming condition will be hereinafter described in detail for each embodiment.

Each of the zoom lens systems according to Embodiments 1 to 3, in order from the object side to the image side, comprises a first lens unit G1 having negative optical power, a second lens unit G2 having positive optical power, a third lens unit G3 having negative optical power, and a fourth lens unit G4 having positive optical power. In the zoom lens system according to each embodiment, in zooming, the first lens unit G1, the second lens unit G2, and the third lens unit G3 individually move in a direction along the optical axis such that the intervals between the respective lens units, that is, the interval between the first lens unit G1 and the second lens unit G2, the interval between the second lens unit G2 and the third lens unit G3, and the interval between the third lens unit G3 and the fourth lens unit G4, vary. In the zoom lens system according to each embodiment, these lens units are arranged in a desired optical power allocation, whereby size reduction of the entire lens system is achieved while maintaining excellent optical performance.

In FIGS. 1, 3, and 5, an asterisk “*” imparted to a particular surface indicates that the surface is aspheric. In each Fig., symbol (+) or (−) imparted to the symbol of each lens unit corresponds to the sign of the optical power of the lens unit. In each Fig., a straight line located on the most right-hand side indicates the position of an image surface S.

Further, as shown in FIGS. 1, 3, and 5, an aperture diaphragm A is provided between the first lens unit G1 and the second lens unit G2. The aperture diaphragm A moves along the optical axis together with the second lens unit G2 in zooming from a wide-angle limit to a telephoto limit at the time of image taking

### Embodiment 1

As shown in FIG. 1, the first lens unit G1, in order from the object side to the image side, comprises: a negative meniscus first lens element L1 with the convex surface facing the object side; a bi-concave second lens element L2; and a positive meniscus third lens element L3 with the convex surface facing the object side. The second lens element L2 has two aspheric surfaces.

The second lens unit G2, in order from the object side to the image side, comprises: a positive meniscus fourth lens element L4 with the convex surface facing the object side; a negative meniscus fifth lens element L5 with the convex surface facing the object side; and a bi-convex sixth lens element L6. Among these, the fifth lens element L5 and the sixth lens element L6 are cemented with each other. In the surface data of the corresponding Numerical Example described later, a surface number 11 is imparted to an adhesive layer between the fifth lens element L5 and the sixth lens element L6. The fourth lens element L4 has two aspheric surfaces.

The entirety of the second lens unit G2 corresponds to an image blur compensating lens unit described later, which moves in a direction perpendicular to the optical axis to optically compensate image blur.

The third lens unit G3 comprises solely a bi-concave seventh lens element L7. The seventh lens element L7 has an aspheric image side surface. The seventh lens element L7 is a lens element formed of a resin material.

The fourth lens unit G4 comprises solely a bi-convex eighth lens element L8.

In zooming from a wide-angle limit to a telephoto limit at the time of image taking, the first lens unit G1 moves with locus of a convex to the image side, the second lens unit G2 moves to the object side, the third lens unit G3 moves with locus of a slight convex to the object side, and the fourth lens unit G4 is fixed with respect to the image surface S. That is, in zooming, the first lens unit G1, the second lens unit G2, and the third lens unit G3 individually move along the optical axis so that the interval between the first lens unit G1 and the second lens unit G2 decreases, and the interval between the second lens unit G2 and the third lens unit G3 and the interval between the third lens unit G3 and the fourth lens unit G4 increase.

In focusing from an infinity in-focus condition to a close-object in-focus condition, the third lens unit G3 serving as a focusing lens unit moves to the image side along the optical axis in any zooming condition.

### Embodiment 2

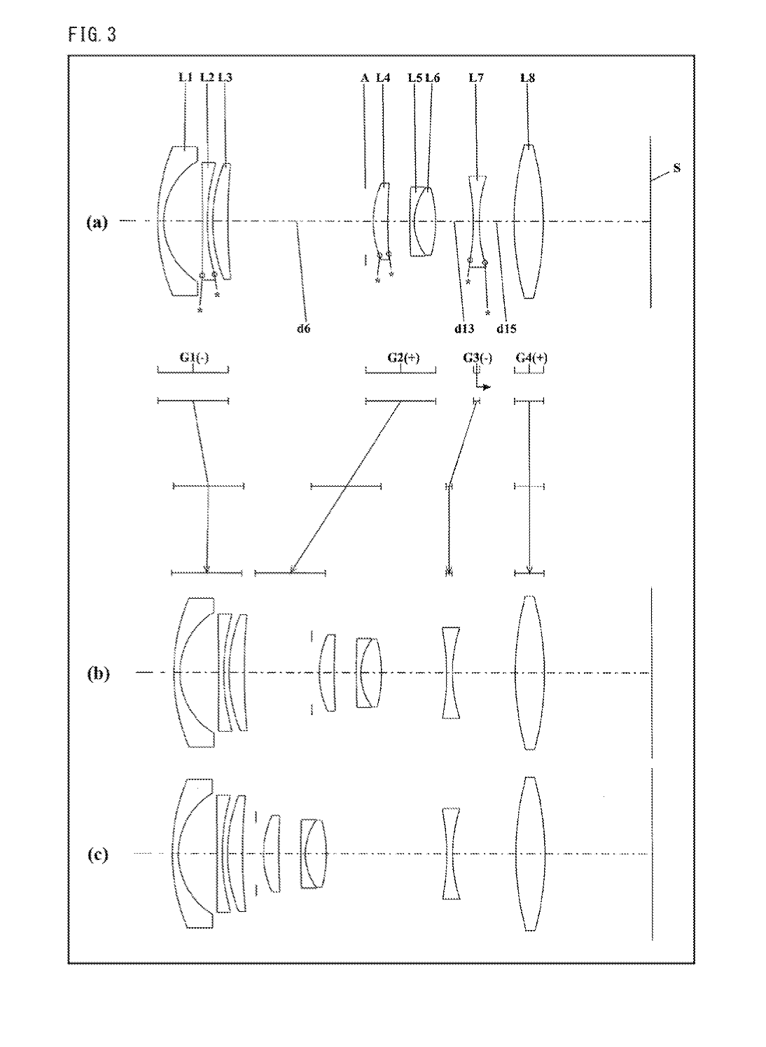

As shown in FIG. 3, the first lens unit G1, in order from the object side to the image side, comprises: a negative meniscus first lens element L1 with the convex surface facing the object side; a bi-concave second lens element L2; and a positive meniscus third lens element L3 with the convex surface facing the object side. The second lens element L2 has two aspheric surfaces.

The second lens unit G2, in order from the object side to the image side, comprises: a positive meniscus fourth lens element L4 with the convex surface facing the object side; a negative meniscus fifth lens element L5 with the convex surface facing the object side; and a bi-convex sixth lens element L6. Among these, the fifth lens element L5 and the sixth lens element L6 are cemented with each other. In the surface data of the corresponding Numerical Example described later, a surface number 11 is imparted to an adhesive layer between the fifth lens element L5 and the sixth lens element L6. The fourth lens element L4 has two aspheric surfaces.

The entirety of the second lens unit G2 corresponds to an image blur compensating lens unit described later, which moves in a direction perpendicular to the optical axis to optically compensate image blur.

The third lens unit G3 comprises solely a bi-concave seventh lens element L7. The seventh lens element L7 has two aspheric surfaces.

The fourth lens unit G4 comprises solely a bi-convex eighth lens element L8.

In zooming from a wide-angle limit to a telephoto limit at the time of image taking, the first lens unit G1 moves with locus of a convex to the image side, the second lens unit G2 moves to the object side, the third lens unit G3 moves with locus of a convex to the object side, and the fourth lens unit G4 is fixed with respect to the image surface S. That is, in zooming, the first lens unit G1, the second lens unit G2, and the third lens unit G3 individually move along the optical axis so that the interval between the first lens unit G1 and the second lens unit G2 decreases, and the interval between the second lens unit G2 and the third lens unit G3 and the interval between the third lens unit G3 and the fourth lens unit G4 increase.

In focusing from an infinity in-focus condition to a close-object in-focus condition, the third lens unit G3 serving as a focusing lens unit moves to the image side along the optical axis in any zooming condition.

### Embodiment 3

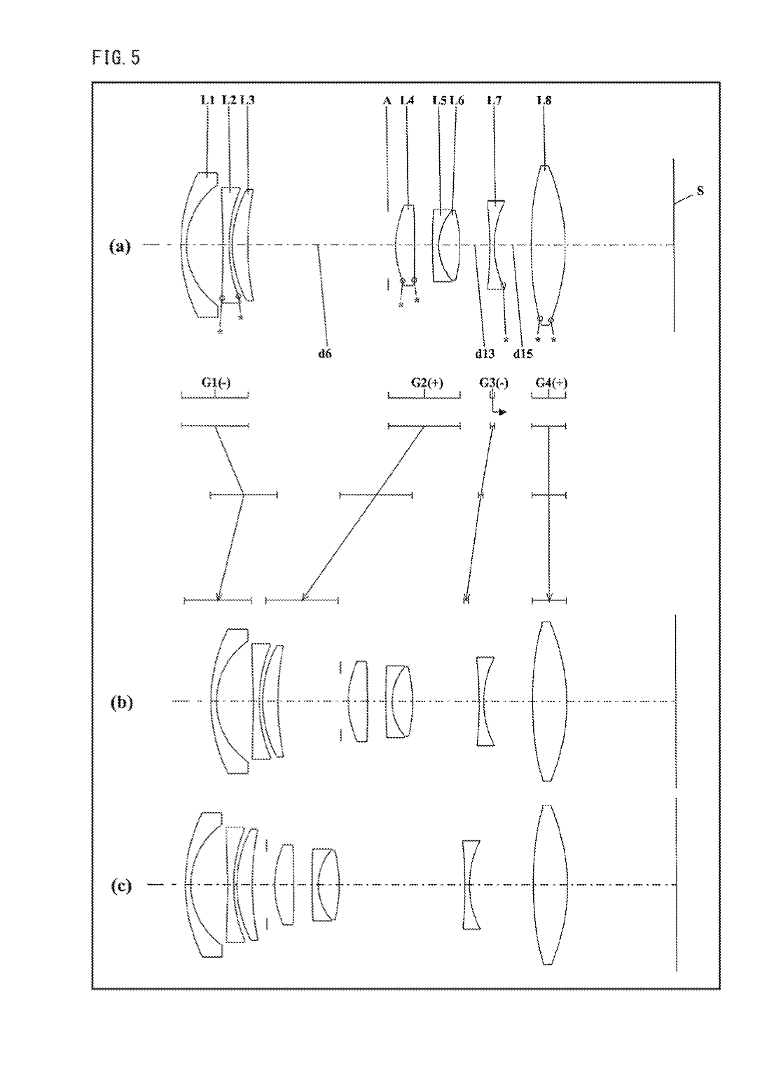

As shown in FIG. 5, the first lens unit G1, in order from the object side to the image side, comprises: a negative meniscus first lens element L1 with the convex surface facing the object side; a bi-concave second lens element L2; and a positive meniscus third lens element L3 with the convex surface facing the object side. The second lens element L2 has two aspheric surfaces.

The second lens unit G2, in order from the object side to the image side, comprises: a bi-convex fourth lens element L4; a negative meniscus fifth lens element L5 with the convex surface facing the object side; and a bi-convex sixth lens element L6. Among these, the fifth lens element L5 and the sixth lens element L6 are cemented with each other. In the surface data of the corresponding Numerical Example described later, a surface number 11 is imparted to an adhesive layer between the fifth lens element L5 and the sixth lens element L6. The fourth lens element L4 has two aspheric surfaces.

The entirety of the second lens unit G2 corresponds to an image blur compensating lens unit described later, which moves in a direction perpendicular to the optical axis to optically compensate image blur.

The third lens unit G3 comprises solely a bi-concave seventh lens element L7. The seventh lens element L7 has an aspheric image side surface. The seventh lens element L7 is a lens element formed of a resin material.

The fourth lens unit G4 comprises solely a bi-convex eighth lens element L8.

In zooming from a wide-angle limit to a telephoto limit at the time of image taking, the first lens unit G1 moves with locus of a convex to the image side, the second lens unit G2 moves to the object side, the third lens unit G3 moves with locus of a slight convex to the object side, and the fourth lens unit G4 is fixed with respect to the image surface S. That is, in zooming, the first lens unit G1, the second lens unit G2, and the third lens unit G3 individually move along the optical axis so that the interval between the first lens unit G1 and the second lens unit G2 decreases, and the interval between the second lens unit G2 and the third lens unit G3 and the interval between the third lens unit G3 and the fourth lens unit G4 increase.

In focusing from an infinity in-focus condition to a close-object in-focus condition, the third lens unit G3 serving as a focusing lens unit moves to the image side along the optical axis in any zooming condition.

In the zoom lens systems according to Embodiments 1 to 3, in zooming from a wide-angle limit to a telephoto limit at the time of image taking, the first lens unit G1 moves with locus of a convex to the image side, and the second lens unit G2 moves to the object side, so that the interval between the first lens unit G1 and the second lens unit G2 is smaller at the telephoto limit than at the wide-angle limit. Thereby, the dimension, in the optical-axis direction, of a zoom cam ring of a lens barrel that moves with the locus of the first lens unit G1 and the second lens unit G2 is reduced, and the length of the lens barrel when retracted can be reduced. As a result, it is possible to provide compact interchangeable lens apparatuses and camera systems.

In the zoom lens systems according to Embodiments 1 to 3, the first lens unit G1, in order from the object side to the image side, comprises: the negative meniscus first lens element L1; the second lens element L2 having negative optical power; and the positive meniscus third lens element L3. At least one of two surfaces of the second lens element L2 having negative optical power is an aspherical surface. Therefore, off-axis aberration at the wide-angle limit can be successfully compensated, thereby realizing excellent optical performance even at a focal length of 24 mm (in still conversion) or smaller.

In the zoom lens systems according to Embodiments 1 to 3, the second lens unit G2, in order from the object side to the image side, comprises: the fourth lens element L4 having positive optical power; and a cemented lens element obtained by cementing the negative meniscus fifth lens element L5 with the sixth lens element L6 having positive optical power. Thereby, the second lens unit G2 has a triplet configuration. The triplet configuration is well known as an optical system suitable for compensation of chromatic aberration and Seidel's five aberrations while having a small number of lenses, i.e., three lenses of positive, negative, and positive powers. Since the present disclosure adopts the triplet configuration, simplified configuration is achieved and the aberrations can be successfully compensated. As a result, it is possible to provide compact interchangeable lens apparatuses and camera systems. Further, as described above, the second lens unit G2 is an image blur compensating lens unit. By using the second lens unit G2 of the above-mentioned lens configuration as an image blur compensating lens unit, size reduction of an actuator can also be achieved.

In the zoom lens systems according to Embodiments 1 and 3, the third lens unit G3 is composed of one lens element formed of a resin material such as acrylic resin. As described above, the third lens unit G3 is a focusing lens unit, and therefore, weight reduction of the focusing lens unit and size reduction of the actuator can be achieved. As a result, further size reduction of the zoom lens system can be achieved, thereby providing compact interchangeable lens apparatuses and camera systems.

It is beneficial to have an image blur compensating lens unit like the zoom lens systems according to Embodiments 1 to 3. The image blur compensating lens unit can compensate image point movement caused by vibration of the entire system.

When compensating image point movement caused by vibration of the entire system, the image blur compensating lens unit moves in the direction perpendicular to the optical axis, whereby image blur is compensated in a state that size increase in the entire zoom lens system is suppressed to realize a compact configuration and that excellent imaging characteristics such as small decentering coma aberration and small decentering astigmatism are satisfied.

As described above, Embodiments 1 to 3 have been described as examples of art disclosed in the present application. However, the art in the present disclosure is not limited to these embodiments. It is understood that various modifications, replacements, additions, omissions, and the like have been performed in these embodiments to give optional embodiments, and the art in the present disclosure can be applied to the optional embodiments.

The following description is given for conditions that a zoom lens system like the zoom lens systems according to Embodiments 1 to 3 can satisfy. Here, a plurality of beneficial conditions is set forth for the zoom lens system according to each embodiment. A construction that satisfies all the plurality of conditions is most effective for the zoom lens system. However, when an individual condition is satisfied, a zoom lens system having the corresponding effect is obtained.

For example, in a zoom lens system like the zoom lens systems according to Embodiments 1 to 3, which comprises, in order from the object side to the image side, a first lens unit having negative optical power, a second lens unit having positive optical power, a third lens unit having negative optical power, and a fourth lens unit having positive optical power, and in which, in zooming from a wide-angle limit to a telephoto limit at the time of image taking, the first lens unit moves with locus of a convex to the image side, and the second lens unit moves to the object side (this lens configuration is referred to as a basic configuration of the embodiment, hereinafter), the following conditions (1) and (2) are satisfied:

0<(D_{aW}−D_{aT})/TL_{W}<0.26 (1)

0<TG_{2G}/TGₐ₁₁<0.4 (2)

where

D_{aW} is an optical axial interval between the first lens unit and the second lens unit at the wide-angle limit,

D_{aT} is an optical axial interval between the first lens unit and the second lens unit at the telephoto limit,

TL_{W} is an overall length of the lens system at the wide-angle limit being an optical axial distance from an object side surface of a lens element closest to the object side in the first lens unit to an image surface,

TG_{2G} is an optical axial thickness of the second lens unit, and

TGₐₗₗ is a sum of optical axial thicknesses of the respective lens units.

The condition (1) sets forth a ratio of a difference between the interval between the first lens unit and the second lens unit at the wide-angle limit and that interval at the telephoto limit, to the overall length of the lens system at the wide-angle limit. When the condition (1) is satisfied, the dimension, in the optical-axis direction, of the zoom cam ring of the lens barrel that moves with the locus of the first lens unit and the second lens unit is reduced, and thereby the length of the lens barrel when retracted can be reduced. As a result, it is possible to provide compact interchangeable lens apparatuses and camera systems.

When at least one of the following conditions (1)′ and (1)″ is satisfied, the above-mentioned effect is achieved more successfully.

0.220<(D_{aW}−D_{aT})/TL_{W} (1)′

(D_{aW}−D_{aT})/TL_{W}<0.258 (1)″

The condition (2) sets forth a ratio of the thickness of the second lens unit to the sum of the thicknesses of the respective lens units. When the condition (2) is satisfied, the ratio of the thickness of the second lens unit to the sum of the thicknesses of the respective lens units is reduced, and thereby the length of the lens barrel when retracted can be reduced. As a result, it is possible to provide compact interchangeable lens apparatuses and camera systems.

When at least one of the following conditions (2)′ and (2)″ is satisfied, the above-mentioned effect is achieved more successfully.

0.350<TG_{2G}/TGₐₗₗ (2)′

TG_{2G}/TGₐₗₗ<0.398 (2)″

It is beneficial that a zoom lens system having the basic configuration like the zoom lens systems according to Embodiments 1 to 3 satisfies the following condition (3):

TL_{W}−TL_{T}>0 (3)

where

TL_{W} is the overall length of the lens system at the wide-angle limit being the optical axial distance from the object side surface of the lens element closest to the object side in the first lens unit to the image surface, and

TL_{T} is an overall length of the lens system at the telephoto limit being an optical axial distance from the object side surface of the lens element closest to the object side in the first lens unit to the image surface.

The condition (3) sets forth a difference between the overall length of the lens system at the wide-angle limit and the overall length of the lens system at the telephoto limit. When the condition (3) is satisfied, the overall length of the lens system at the wide-angle limit becomes larger than the overall length of the lens system at the telephoto limit, whereby the dimension, in the optical-axis direction, of the zoom cam ring of the lens barrel is further reduced, and the length of the lens barrel when retracted can be further reduced. As a result, it is possible to provide more compact interchangeable lens apparatuses and camera systems.

When the following condition (3)′ is satisfied, the above-mentioned effect is achieved more successfully.

TL_{W}−TL_{T}>0.20 (3)′

It is beneficial that a zoom lens system having the basic configuration like the zoom lens systems according to Embodiments 1 to 3 satisfies the following condition (4):

0<TGₐₗₗ/TL_{W}<0.35 (4)

where

TGₐₗₗ is the sum of the optical axial thicknesses of the respective lens units, and

TL_{W} is the overall length of the lens system at the wide-angle limit being the optical axial distance from the object side surface of the lens element closest to the object side in the first lens unit to the image surface.

The condition (4) sets forth a ratio of the sum of the thicknesses of the respective lens units to the overall length of the lens system at the wide-angle limit. When the condition (4) is satisfied, the ratio of the sum of the thicknesses of the respective lens units to the overall length of the lens system at the wide-angle limit is reduced, and thereby the length of the lens barrel when retracted can be further reduced. As a result, it is possible to provide more compact interchangeable lens apparatuses and camera systems.

When at least one of the following conditions (4)′ and (4)″ is satisfied, the above-mentioned effect is achieved more successfully.

0.320<TGₐₗₗ/TL_{W} (4)′

TGₐₗₗ/TL_{W}<0.348 (4)″

It is beneficial that a zoom lens system having the basic configuration like the zoom lens systems according to Embodiments 1 to 3 satisfies the following condition (5).

nd_{L1}>1.9 (5)

where

nd_{L1} is a refractive index to the d-line of the lens element closest to the object side in the first lens unit.

The condition (5) sets forth the refractive index to the d-line of the lens element closest to the object side in the first lens unit, i.e., the first lens element. When the condition (5) is satisfied, it is possible to realize a zoom lens system having a small lens diameter in spite of its wide view angle.

When the following condition (5)′ is satisfied, the above-mentioned effect is achieved more successfully.

nd_{L1}>1.902 (5)′

It is beneficial that a zoom lens system having the basic configuration like the zoom lens systems according to Embodiments 1 to 3 satisfies the following condition (6).

|Σ1/(fᵢ×νdᵢ)|<5.0E-04 (6)

where

fᵢ is a focal length of an i-th lens element from the object side in the second lens unit,

νdᵢ is an Abbe number to the d-line of the i-th lens element from the object side in the second lens unit.

The condition (6) sets forth a condition relating to reduction of chromatic aberration in the second lens unit. When the condition (6) is satisfied, it is possible to realize a zoom lens system in which axial chromatic aberration is successfully compensated, in spite of its wide view angle.

When the following condition (6)′ is satisfied, the above-mentioned effect is achieved more successfully.

|Σ1/(fᵢ×νdᵢ)|<4.5E-04 (6)′

The individual lens units constituting the zoom lens systems according to Embodiments 1 to 3 are each composed exclusively of refractive type lens elements that deflect incident light by refraction (that is, lens elements of a type in which deflection is achieved at the interface between media having different refractive indices). However, the present disclosure is not limited to this construction. For example, the lens units may employ diffractive type lens elements that deflect incident light by diffraction; refractive-diffractive hybrid type lens elements that deflect incident light by a combination of diffraction and refraction; or gradient index type lens elements that deflect incident light by distribution of refractive index in the medium. In particular, in the refractive-diffractive hybrid type lens element, when a diffraction structure is formed in the interface between media having different refractive indices, wavelength dependence of the diffraction efficiency is improved. Thus, such a configuration is beneficial.

### Embodiment 4

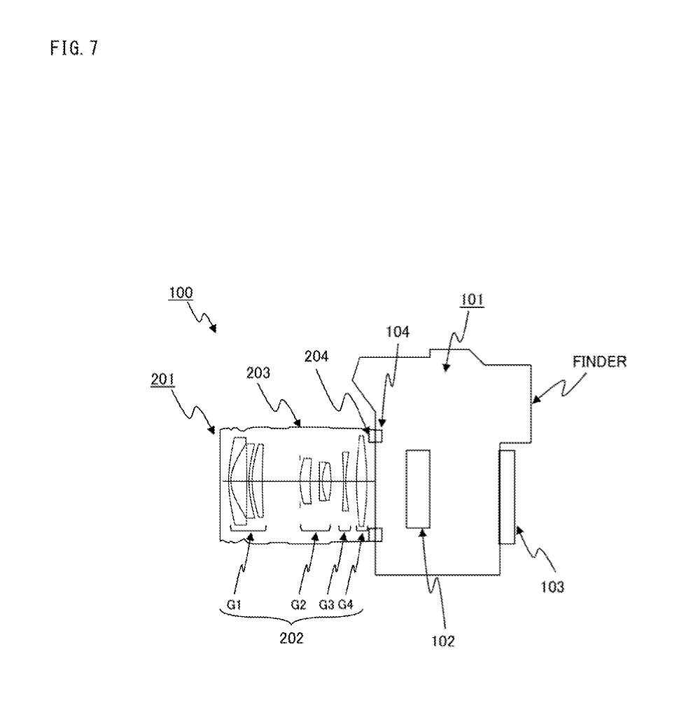

FIG. 7 is a schematic construction diagram of an interchangeable-lens type digital camera system according to Embodiment 4.

The interchangeable-lens type digital camera system 100 according to Embodiment 4 includes a camera body 101, and an interchangeable lens apparatus 201 which is detachably connected to the camera body 101.

The camera body 101 includes: an image sensor 102 which receives an optical image formed by a zoom lens system 202 of the interchangeable lens apparatus 201, and converts the optical image into an electric image signal; a liquid crystal monitor 103 which displays the image signal obtained by the image sensor 102; and a camera mount section 104. On the other hand, the interchangeable lens apparatus 201 includes: a zoom lens system 202 according to any of Embodiments 1 to 3; a lens barrel 203 which holds the zoom lens system 202; and a lens mount section 204 connected to the camera mount section 104 of the camera body 101. The camera mount section 104 and the lens mount section 204 are physically connected to each other. Moreover, the camera mount section 104 and the lens mount section 204 function as interfaces which allow the camera body 101 and the interchangeable lens apparatus 201 to exchange signals, by electrically connecting a controller (not shown) in the camera body 101 and a controller (not shown) in the interchangeable lens apparatus 201. In FIG. 7, the zoom lens system according to Embodiment 1 is employed as the zoom lens system 202.

In Embodiment 4, since the zoom lens system 202 according to any of Embodiments 1 to 3 is employed, a compact interchangeable lens apparatus having excellent imaging performance can be realized at low cost. Moreover, size reduction and cost reduction of the entire camera system 100 according to Embodiment 4 can be achieved. In the zoom lens systems according to Embodiments 1 to 3, the entire zooming range need not be used. That is, in accordance with a desired zooming range, a range where satisfactory optical performance is obtained may exclusively be used. Then, the zoom lens system may be used as one having a lower magnification than the zoom lens systems described in Embodiments 1 to 3.

As described above, Embodiment 4 has been described as an example of art disclosed in the present application. However, the art in the present disclosure is not limited to this embodiment. It is understood that various modifications, replacements, additions, omissions, and the like have been performed in this embodiment to give optional embodiments, and the art in the present disclosure can be applied to the optional embodiments.

Numerical examples are described below in which the zoom lens systems according to Embodiments 1 to 3 are implemented. Here, in the numerical examples, the units of length are all “mm”, while the units of view angle are all “°”. Moreover, in the numerical examples, r is the radius of curvature, d is the axial distance, nd is the refractive index to the d-line, and vd is the Abbe number to the d-line. In the numerical examples, the surfaces marked with * are aspherical surfaces, and the aspherical surface configuration is defined by the following expression.

$$Z = \frac{{h}^{2} / r}{1 + \sqrt{1 - ( 1 + κ ) {( h / r )}^{2}}} + \sum {A}_{n} {h}^{n}$$

Here, the symbols in the formula indicate the following quantities.

Z is a distance from a point on an aspherical surface at a height h relative to the optical axis to a tangential plane at the vertex of the aspherical surface,

h is a height relative to the optical axis,

r is a radius of curvature at the top,

κ is a conic constant, and

Aₙ is a n-th order aspherical coefficient.

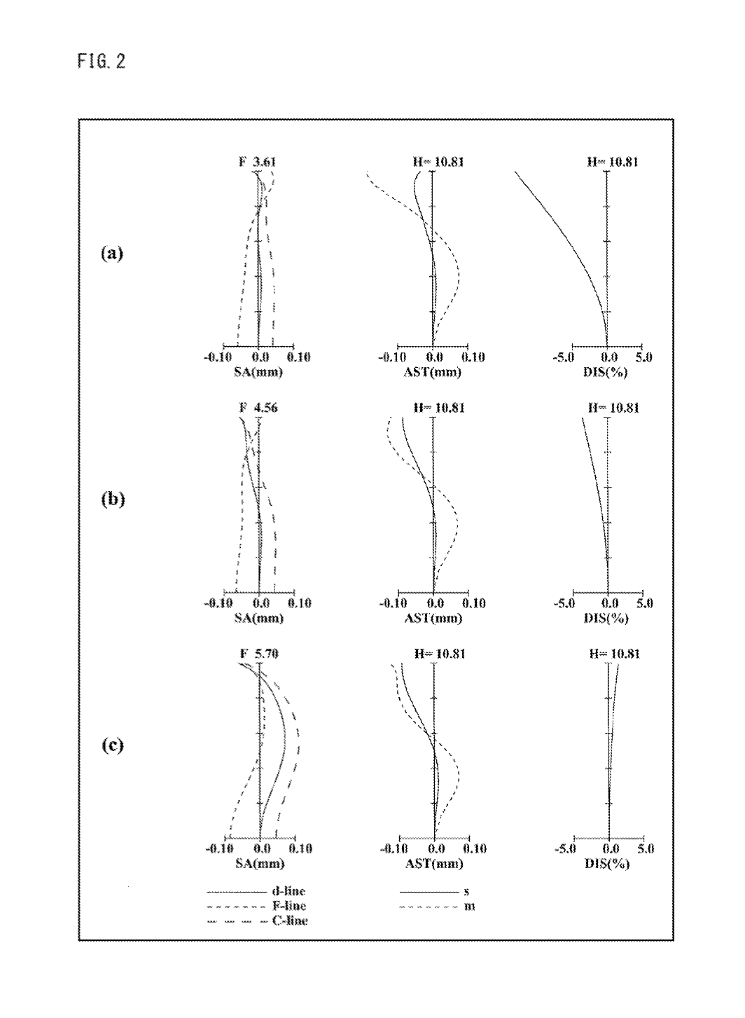

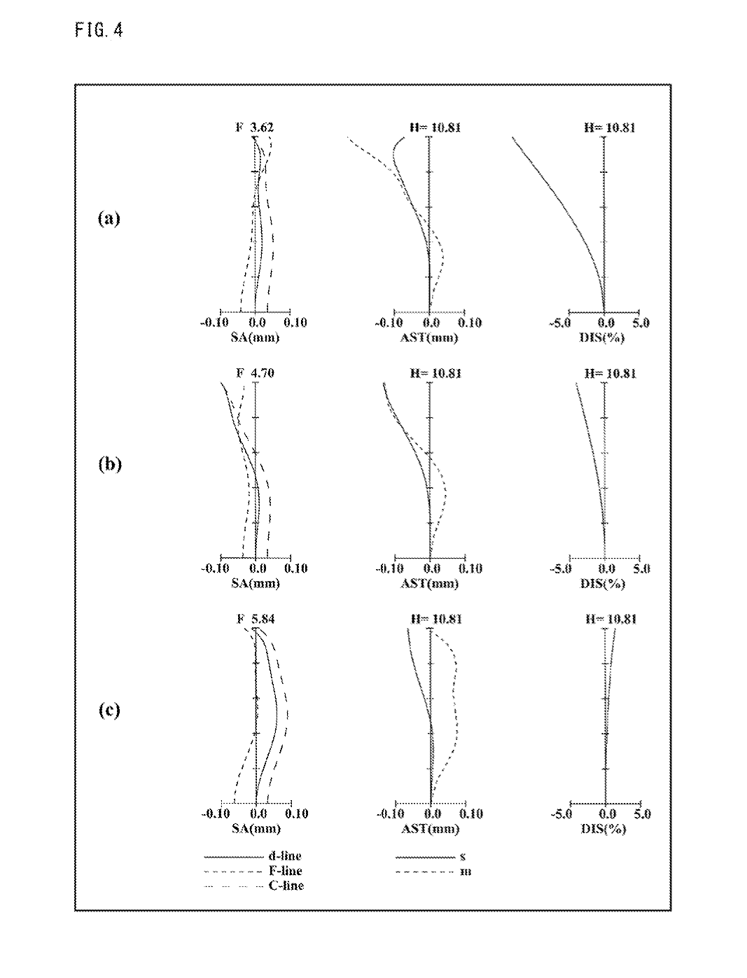

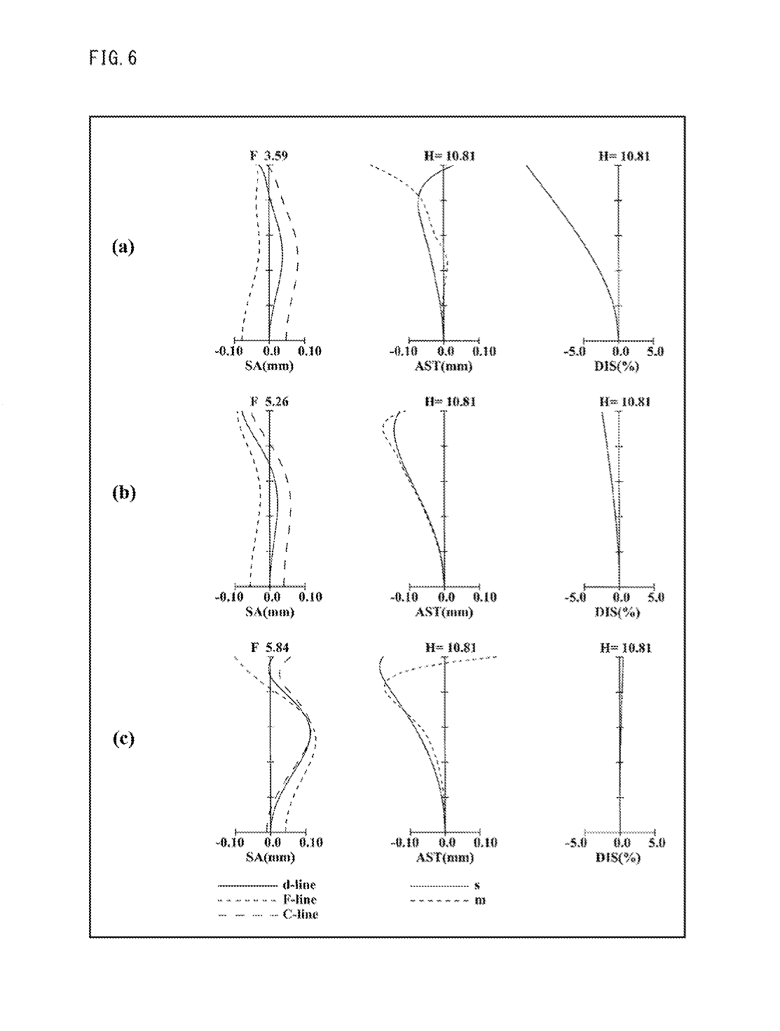

FIGS. 2, 4, and 6 are longitudinal aberration diagrams of an infinity in-focus condition of the zoom lens systems according to Numerical Examples 1 to 3, respectively.

In each longitudinal aberration diagram, part (a) shows the aberration at a wide-angle limit, part (b) shows the aberration at a middle position, and part (c) shows the aberration at a telephoto limit. Each longitudinal aberration diagram, in order from the left-hand side, shows the spherical aberration (SA (mm)), the astigmatism (AST (mm)) and the distortion (DIS (%)). In each spherical aberration diagram, the vertical axis indicates the F-number (in each Fig., indicated as F), and the solid line, the short dash line and the long dash line indicate the characteristics to the d-line, the F-line and the C-line, respectively. In each astigmatism diagram, the vertical axis indicates the image height (in each Fig., indicated as H), and the solid line and the dash line indicate the characteristics to the sagittal plane (in each Fig., indicated as “s”) and the meridional plane (in each Fig., indicated as “m”), respectively. In each distortion diagram, the vertical axis indicates the image height (in each Fig., indicated as H).

### Numerical Example 1

The zoom lens system of Numerical Example 1 corresponds to Embodiment 1 shown in FIG. 1. Table 1 shows the surface data of the zoom lens system of Numerical Example 1. Table 2 shows the aspherical data. Table 3 shows the various data.

TABLE 1
(Surface data)

| Surface number | r | d | nd | vd |
|---|---|---|---|---|
| Object surface | ∞ | | | |
| 1 | 30.49670 | 0.80000 | 1.91082 | 35.2 |
| 2 | 9.57330 | 4.67870 | | |
| 3* | −250.00000 | 0.65000 | 1.80755 | 40.9 |
| 4* | 23.82190 | 0.70000 | | |
| 5 | 20.15200 | 2.29900 | 1.92286 | 20.9 |
| 6 | 154.75950 | Variable | | |
| 7(Diaphragm) | ∞ | 1.00000 | | |
| 8* | 12.06370 | 2.90000 | 1.80755 | 40.9 |
| 9* | 72.81590 | 2.50090 | | |
| 10 | 162.28230 | 0.60000 | 1.90366 | 31.3 |
| 11 | 8.22930 | 0.01000 | 1.56732 | 42.8 |
| 12 | 8.22930 | 2.80000 | 1.59282 | 68.6 |
| 13 | −15.07320 | Variable | | |
| 14 | −36.48910 | 0.60000 | 1.51633 | 64.1 |
| 15* | 19.51650 | Variable | | |
| 16 | 38.04970 | 3.76140 | 1.59349 | 67.0 |
| 17 | −38.04970 | (BF) | | |
| Image surface | ∞ | | | |

TABLE 2
(Aspherical data)

Surface No. 3
K = 0.00000E+00, A4 = 6.42456E−05, A6 = −1.48819E−06,
A8 = 1.91171E−08 A10 = −1.41959E−10, A12 = 0.00000E+00
Surface No. 4
K = −1.00000E+00, A4 = 4.34003E−05, A6 = −1.90102E−06,
A8 = 2.13128E−08 A10 = −1.83613E−10, A12 = 0.00000E+00
Surface No. 8
K = 0.00000E+00, A4 = 1.75599E−05, A6 = 1.10808E−06,
A8 = −7.85898E−08 A10 = 1.60668E−09, A12 = 0.00000E+00
Surface No. 9
K = 0.00000E+00, A4 = 1.17843E−04, A6 = 9.94808E−07,
A8 = −9.50843E−08 A10 = 2.13059E−09, A12 = 0.00000E+00
Surface No. 15
K = 0.00000E+00, A4 = 6.54271E−05, A6 = −2.79405E−06,
A8 = 1.21768E−07 A10 = −2.82845E−09, A12 = 2.56285E−11

TABLE 3
(Various data)
Zooming ratio 2.29667

| | Wide-angle | Middle | Telephoto |
|---|---|---|---|
| | limit | position | limit |
| Focal length | 12.5400 | 18.9540 | 28.8002 |
| F-number | 3.60581 | 4.55961 | 5.69578 |
| Half view angle | 44.8139 | 30.6293 | 20.3145 |
| Image height | 10.8150 | 10.8150 | 10.8150 |
| Overall length | 66.1576 | 63.1222 | 64.2717 |
| of lens system | | | |
| BF | 14.19898 | 14.19917 | 14.19933 |
| d6 | 18.4000 | 9.1818 | 2.5475 |
| d13 | 5.9766 | 9.9097 | 16.4293 |
| d15 | 4.2820 | 6.5315 | 7.7956 |
| Entrance pupil | 10.3509 | 8.4954 | 6.3952 |
| position | | | |
| Exit pupil | −28.3422 | −43.7086 | −64.6559 |
| position | | | |
| Front principal | 19.1944 | 21.2455 | 24.6767 |
| points position | | | |
| Back principal | 53.6176 | 44.1681 | 35.4716 |
| points position | | | |

Single lens data

| Lens | Initial surface | Focal |
|---|---|---|
| element | number | length |
| 1 | 1 | −15.6040 |
| 2 | 3 | −26.9041 |
| 3 | 5 | 24.9015 |
| 4 | 8 | 17.5312 |
| 5 | 10 | −9.6109 |
| 6 | 12 | 9.3996 |
| 7 | 14 | −24.5372 |
| 8 | 16 | 32.6569 |

Zoom lens unit data

| | | | | Front | Back |
|---|---|---|---|---|---|
| | Initial | | Overall | principal | principal |
| Lens | surface | Focal | length of | points | points |
| unit | No. | length | lens unit | position | position |
| 1 | 1 | −17.34042 | 9.12770 | −0.08239 | 1.33503 |
| 2 | 7 | 16.66030 | 9.81090 | 2.54959 | 4.33557 |
| 3 | 14 | −24.53719 | 0.60000 | 0.25687 | 0.46261 |
| 4 | 16 | 32.65691 | 3.76140 | 1.20237 | 2.55903 |

Magnification of zoom lens unit

| | Initial | | | |
|---|---|---|---|---|
| Lens | surface | Wide-angle | Middle | Telephoto |
| unit | No. | limit | position | limit |
| 1 | 1 | 0.00000 | 0.00000 | 0.00000 |
| 2 | 7 | −0.56625 | −0.82460 | −1.22774 |
| 3 | 14 | 2.41701 | 2.50872 | 2.56026 |
| 4 | 16 | 0.52839 | 0.52838 | 0.52838 |

### Numerical Example 2

The zoom lens system of Numerical Example 2 corresponds to Embodiment 2 shown in FIG. 3. Table 4 shows the surface data of the zoom lens system of Numerical Example 2. Table 5 shows the aspherical data. Table 6 shows the various data.

TABLE 4
(Surface data)

| Surface number | r | d | nd | vd |
|---|---|---|---|---|
| Object surface | ∞ | | | |
| 1 | 25.11400 | 0.80000 | 1.90366 | 31.3 |
| 2 | 9.32200 | 5.15000 | | |
| 3* | −100.00000 | 0.65000 | 1.80755 | 40.9 |
| 4* | 29.48100 | 0.70000 | | |
| 5 | 20.44000 | 2.00000 | 1.94595 | 18.0 |
| 6 | 79.77000 | Variable | | |
| 7(Diaphragm) | ∞ | 1.00000 | | |
| 8* | 11.88800 | 2.00000 | 1.80755 | 40.9 |
| 9* | 130.07200 | 2.92000 | | |
| 10 | 97.99300 | 0.60000 | 1.90366 | 31.3 |
| 11 | 7.45200 | 0.01000 | 1.56732 | 42.8 |
| 12 | 7.45200 | 2.80000 | 1.59282 | 68.6 |
| 13 | −16.34800 | Variable | | |
| 14* | −35.24500 | 0.80000 | 1.54360 | 56.0 |
| 15* | 18.97400 | Variable | | |
| 16 | 38.20700 | 3.87000 | 1.61800 | 63.4 |
| 17 | −38.20700 | (BF) | | |
| Image surface | ∞ | | | |

TABLE 5
(Aspherical data)

Surface No. 3
K = 0.00000E+00, A4 = 1.40550E−04, A6 = −1.58941E−06,
A8 = 6.43519E−09 A10 = −1.87697E−11, A12 = 0.00000E+00
Surface No. 4
K = 5.86836E−01, A4 = 1.15112E−04, A6 = −1.97769E−06,
A8 = 6.16703E−09 A10 = −4.93618E−11, A12 = 0.00000E+00
Surface No. 8
K = 0.00000E+00, A4 = 3.20964E−06, A6 = 2.93568E−06,
A8 = −1.57598E−07 A10 = 3.09974E−09, A12 = 0.00000E+00
Surface No. 9
K = 0.00000E+00, A4 = 8.54042E−05, A6 = 2.80481E−06,
A8 = −1.72924E−07 A10 = 3.57409E−09, A12 = 0.00000E+00
Surface No. 14
K = 0.00000E+00, A4 = −2.30192E−04, A6 = 9.60767E−06,
A8 = −1.56985E−07 A10 = 9.91907E−10, A12 = 0.00000E+00
Surface No. 15
K = 0.00000E+00, A4 = −1.70128E−04, A6 = 7.65291E−06,
A8 = −8.80044E−08 A10 = −1.19460E−09, A12 = 2.87826E−11

TABLE 6
(Various data)
Zooming ratio 2.46153

| | Wide-angle | Middle | Telephoto |
|---|---|---|---|
| | limit | position | limit |
| Focal length | 12.4800 | 19.5303 | 30.7200 |
| F-number | 3.62286 | 4.70493 | 5.83562 |
| Half view angle | 44.9235 | 29.9783 | 19.1404 |
| Image height | 10.8150 | 10.8150 | 10.8150 |
| Overall length | 65.3658 | 63.3359 | 63.6079 |
| of lens system | | | |
| BF | 14.19915 | 14.19920 | 14.19922 |
| d6 | 18.2733 | 8.9425 | 1.7736 |
| d13 | 4.9675 | 8.6184 | 16.0093 |
| d15 | 4.6258 | 8.2758 | 8.3258 |
| Entrance pupil | 10.6761 | 8.7730 | 6.3908 |
| position | | | |
| Exit pupil | −27.9972 | −51.8418 | −68.7119 |
| position | | | |
| Front principal | 19.4651 | 22.5276 | 25.7285 |
| points position | | | |
| Back principal | 52.8857 | 43.8056 | 32.8879 |
| points position | | | |

Single lens data

| Lens | Initial surface | Focal |
|---|---|---|
| element | number | length |
| 1 | 1 | −16.8095 |
| 2 | 3 | −28.1316 |
| 3 | 5 | 28.5839 |
| 4 | 8 | 16.0803 |
| 5 | 10 | −8.9534 |
| 6 | 12 | 9.0298 |
| 7 | 14 | −22.5722 |
| 8 | 16 | 31.5217 |

Zoom lens unit data

| | | | | Front | Back |
|---|---|---|---|---|---|
| | Initial | | Overall | principal | principal |
| Lens | surface | Focal | length of | points | points |
| unit | No. | length | lens unit | position | position |
| 1 | 1 | −17.05925 | 9.30000 | 0.42826 | 1.90725 |
| 2 | 7 | 15.96962 | 9.33000 | 2.28401 | 3.78521 |
| 3 | 14 | −22.57224 | 0.80000 | 0.33516 | 0.61957 |
| 4 | 16 | 31.52167 | 3.87000 | 1.21951 | 2.65049 |

Magnification of zoom lens unit

| | Initial | | | |
|---|---|---|---|---|
| Lens | surface | Wide-angle | Middle | Telephoto |
| unit | No. | limit | position | limit |
| 1 | 1 | 0.00000 | 0.00000 | 0.00000 |
| 2 | 7 | −0.54992 | −0.81027 | −1.27349 |
| 3 | 14 | 2.60409 | 2.76580 | 2.76802 |
| 4 | 16 | 0.51086 | 0.51085 | 0.51085 |

### Numerical Example 3

The zoom lens system of Numerical Example 3 corresponds to Embodiment 3 shown in FIG. 5. Table 7 shows the surface data of the zoom lens system of Numerical Example 3. Table 8 shows the aspherical data. Table 9 shows the various data.

TABLE 7
(Surface data)

| Surface number | r | d | nd | vd |
|---|---|---|---|---|
| Object surface | ∞ | | | |
| 1 | 21.00190 | 0.70000 | 1.95375 | 32.3 |
| 2 | 9.60990 | 4.81600 | | |
| 3* | −71.95040 | 0.80000 | 1.80998 | 40.9 |
| 4* | 22.31910 | 0.41100 | | |
| 5 | 15.17570 | 1.99480 | 2.00272 | 19.3 |
| 6 | 36.47600 | Variable | | |
| 7(Diaphragm) | ∞ | 1.00000 | | |
| 8* | 11.84810 | 2.50000 | 1.80998 | 40.9 |
| 9* | −220.70170 | 2.38600 | | |
| 10 | 89.66070 | 0.80000 | 1.90366 | 31.3 |
| 11 | 6.83550 | 0.01000 | 1.56732 | 42.8 |
| 12 | 6.83550 | 2.74830 | 1.59282 | 68.6 |
| 13 | −18.13250 | Variable | | |
| 14 | −60.36680 | 0.60000 | 1.51760 | 63.5 |
| 15* | 12.95890 | Variable | | |
| 16* | 60.77360 | 4.45510 | 1.58913 | 61.3 |
| 17* | −24.74990 | (BF) | | |
| Image surface | ∞ | | | |

TABLE 8
(Aspherical data)

Surface No. 3
K = 0.00000E+00, A4 = 7.75922E−05, A6 = 1.09510E−06,
A8 = −4.41288E−08 A10 = 3.92774E−10
Surface No. 4
K = 0.00000E+00, A4 = 8.43604E−05, A6 = 1.49011E−06,
A8 = −6.21553E−08 A10 = 5.77970E−10
Surface No. 8
K = 0.00000E+00, A4 = −5.38137E−05, A6 = 6.17057E−07,
A8 = −9.65154E−08 A10 = −3.50025E−10
Surface No. 9
K = 0.00000E+00, A4 = 2.99230E−05, A6 = 2.22507E−07,
A8 = −1.34771E−07 A10 = 6.22151E−10
Surface No. 15
K = 0.00000E+00, A4 = 1.11804E−04, A6 = −2.09485E−06,
A8 = 0.00000E+00 A10 = 0.00000E+00
Surface No. 16
K = 0.00000E+00, A4 = 5.08926E−05, A6 = −1.10680E−07,
A8 = 0.00000E+00 A10 = 0.00000E+00
Surface No. 17
K = 0.00000E+00, A4 = 5.67430E−06, A6 = 5.75636E−08,
A8 = 0.00000E+00 A10 = 0.00000E+00

TABLE 9
(Various data)
Zooming ratio 2.74164

| | Wide-angle | Middle | Telephoto |
|---|---|---|---|
| | limit | position | limit |
| Focal length | 12.5399 | 20.7134 | 34.3799 |
| F-number | 3.58518 | 5.25686 | 5.83600 |
| Half view angle | 44.7801 | 28.1443 | 17.3825 |
| Image height | 10.8150 | 10.8150 | 10.8150 |
| Overall length | 64.4404 | 60.6907 | 64.1196 |
| of lens system | | | |
| BF | 14.19787 | 14.19842 | 14.19834 |
| d6 | 18.3000 | 8.1818 | 1.8918 |
| d13 | 3.9057 | 8.6887 | 16.4544 |
| d15 | 4.8156 | 6.4006 | 8.3539 |
| Entrance pupil | 10.9672 | 8.7488 | 6.4021 |
| position | | | |
| Exit pupil | −28.3950 | −43.2335 | −75.5372 |
| position | | | |
| Front principal | 19.8152 | 21.9917 | 27.6102 |
| points position | | | |
| Back principal | 51.9004 | 39.9773 | 29.7397 |
| points position | | | |

Single lens data

| Lens | Initial surface | Focal |
|---|---|---|
| element | number | length |
| 1 | 1 | −19.1501 |
| 2 | 3 | −20.9517 |
| 3 | 5 | 24.7565 |
| 4 | 8 | 13.9495 |
| 5 | 10 | −8.2262 |
| 6 | 12 | 8.7314 |
| 7 | 14 | −20.5545 |
| 8 | 16 | 30.4411 |

Zoom lens unit data

| | | | | Front | Back |
|---|---|---|---|---|---|
| | Initial | | Overall | principal | principal |
| Lens | surface | Focal | length of | points | points |
| unit | No. | length | lens unit | position | position |
| 1 | 1 | −16.09156 | 8.72180 | 1.38242 | 3.31821 |
| 2 | 7 | 14.82467 | 9.44430 | 1.81106 | 3.80453 |
| 3 | 14 | −20.55451 | 0.60000 | 0.32458 | 0.53032 |
| 4 | 16 | 30.44114 | 4.45510 | 2.03141 | 3.62782 |

Magnification of zoom lens unit

| | Initial | | | |
|---|---|---|---|---|
| Lens | surface | Wide-angle | Middle | Telephoto |
| unit | No. | limit | position | limit |
| 1 | 1 | 0.00000 | 0.00000 | 0.00000 |
| 2 | 7 | −0.55354 | −0.88966 | −1.42911 |
| 3 | 14 | 2.77995 | 2.85717 | 2.95219 |
| 4 | 16 | 0.50642 | 0.50640 | 0.50640 |

The following Table 10 shows the corresponding values to the individual conditions in the zoom lens systems of each of Numerical Examples.

TABLE 10
(Values corresponding to conditions)

| | | Numerical Example | | |
|---|---|---|---|---|
| Condition | | 1 | 2 | 3 |
| (1) | (D_{aW} − D_{aT})/TL_{W} | 0.240 | 0.252 | 0.255 |
| (2) | TG_{2G}/TGₐₗₗ | 0.395 | 0.374 | 0.380 |
| (3) | TL_{W} − TL_{T} | 1.89 | 1.76 | 0.32 |
| (4) | TGₐₗₗ/TL_{W} | 0.337 | 0.341 | 0.345 |
| (5) | nd_{L1} | 1.91082 | 1.90366 | 1.95375 |
| (6) | \|Σ1/(fᵢ × vdᵢ)\| | 3.785E−04 | 4.334E−04 | 2.743E−05 |

The present disclosure is applicable to a digital still camera, a digital video camera, a camera for a mobile terminal device such as a smart-phone, a camera for a PDA (Personal Digital Assistance), a surveillance camera in a surveillance system, a Web camera, a vehicle-mounted camera or the like. In particular, the present disclosure is applicable to a photographing optical system where high image quality is required like in a digital still camera system or a digital video camera system.

Also, the present disclosure is applicable to, among the interchangeable lens apparatuses according to the present disclosure, an interchangeable lens apparatus having motorized zoom function, i.e., activating function for the zoom lens system by a motor, with which a digital video camera system is provided.

As described above, embodiments have been described as examples of art in the present disclosure. Thus, the attached drawings and detailed description have been provided.

Therefore, in order to illustrate the art, not only essential elements for solving the problems but also elements that are not necessary for solving the problems may be included in elements appearing in the attached drawings or in the detailed description. Therefore, such unnecessary elements should not be immediately determined as necessary elements because of their presence in the attached drawings or in the detailed description.

Further, since the embodiments described above are merely examples of the art in the present disclosure, it is understood that various modifications, replacements, additions, omissions, and the like can be performed in the scope of the claims or in an equivalent scope thereof.

What is claimed is:

1. A zoom lens system, in order from an object side to an image side, comprising:
a first lens unit having negative optical power;
a second lens unit having positive optical power;
a third lens unit having negative optical power; and
a fourth lens unit having positive optical power, wherein
the first lens unit moves with locus of a convex to the image side in zooming from a wide-angle limit to a telephoto limit at a time of image taking
the second lens unit moves to the object side in the zooming, and
the following conditions (1) and (2) are satisfied:
0<(D_{aW}−D_{aT})/TL_{W}<0.26 (1)
0<TG_{2G}/TGₐ₁₁<0.4 (2)
where
D_{aW} is an optical axial interval between the first lens unit and the second lens unit at the wide-angle limit,
D_{aT} is an optical axial interval between the first lens unit and the second lens unit at the telephoto limit,
TL_{W} is an overall length of the lens system at the wide-angle limit being an optical axial distance from an object side surface of a lens element closest to the object side in the first lens unit to an image surface,
TG_{2G} is an optical axial thickness of the second lens unit, and
TGₐₗₗ is a sum of optical axial thicknesses of the respective lens units.

2. The zoom lens system as claimed in claim 1, wherein
the following condition (3) is satisfied:
TL_{W}−TL_{T}>0 (3)
where
TL_{W} is the overall length of the lens system at the wide-angle limit being the optical axial distance from the object side surface of the lens element closest to the object side in the first lens unit to the image surface, and
TL_{T} is an overall length of the lens system at the telephoto limit being an optical axial distance from the object side surface of the lens element closest to the object side in the first lens unit to the image surface.

3. The zoom lens system as claimed in claim 1, wherein
the following condition (4) is satisfied:
0<TGₐₗₗ/TL_{W}<0.35 (4)
where
TGₐₗₗ is the sum of the optical axial thicknesses of the respective lens units, and
TL_{W} is the overall length of the lens system at the wide-angle limit being the optical axial distance from the object side surface of the lens element closest to the object side in the first lens unit to the image surface.

4. The zoom lens system as claimed in claim 1, wherein
the first lens unit, in order from the object side to the image side, comprises: a negative meniscus lens element; a lens element having negative optical power; and a positive meniscus lens element, and
at least one of two surfaces of the lens element having negative optical power is an aspherical surface.

5. The zoom lens system as claimed in claim 1, wherein
the following condition (5) is satisfied:
nd_{L1}>1.9 (5)
where
nd_{L1} is a refractive index to the d-line of the lens element closest to the object side in the first lens unit.

6. The zoom lens system as claimed in claim 1, wherein
the second lens unit, in order from the object side to the image side, comprises: a lens element having positive optical power; and a cemented lens element obtained by cementing a negative meniscus lens element with a lens element having positive optical power.

7. The zoom lens system as claimed in claim 1, wherein
the following condition (6) is satisfied:

|Σ1/(fᵢ×νdᵢ)|<5.0E-04 (6)
where
fᵢ is a focal length of an i-th lens element from the object side in the second lens unit,
νdᵢ is an Abbe number to the d-line of the i-th lens element from the object side in the second lens unit.

8. The zoom lens system as claimed in claim 1, wherein
the third lens unit is composed of one lens element formed of a resin material.

9. An interchangeable lens apparatus comprising:
the zoom lens system as claimed in claim 1; and
a lens mount section which is connectable to a camera body including an image sensor for receiving an optical image formed by the zoom lens system and converting the optical image into an electric image signal.

10. A camera system comprising:
an interchangeable lens apparatus including the zoom lens system as claimed in claim 1; and
a camera body which is detachably connected to the interchangeable lens apparatus via a camera mount section, and includes an image sensor for receiving an optical image formed by the zoom lens system and converting the optical image into an electric image signal.
